(19) United States
(12) Patent Application Publication
(10) Pub. No.: US 2013/0086547 A1
(43) Pub. Date: Apr. 4, 2013

(54) REAL-TIME OPERATIONAL REPORTING AND ANALYTICS ON DEVELOPMENT ENTITIES

(71) Applicants: Bare Said, St. Leon (DE); Frank Brunswig, Heidelberg (DE); Frank Jentsch, Muehlhausen (DE)

(72) Inventors: Bare Said, St. Leon (DE); Frank Brunswig, Heidelberg (DE); Frank Jentsch, Muehlhausen (DE)

(21) Appl. No.: 13/249,231

(22) Filed: Sep. 29, 2011

(51) Int. Cl. G06F 9/44

(52) U.S. Cl. 717/104

(57) ABSTRACT

Methods and apparatus, including computer program products, are provided for reporting and analytics for development entities. In one aspect, there is provided a computer-implemented method. The method may include selecting a development entity model for generating a report including development information regarding the development entities corresponding to the selected model, the development entity model representing an element being developed for a system; configuring a report model for the selected development entity model to enable creation of the report model; and saving the report model for the selected development entity model, the saved report model stored with other report models defining other reports for operational business objects used in conjunction with the system. Related apparatus, systems, methods, and articles are also described.

### FIELD

The present disclosure generally relates to reporting and analytics for development entities.

### BACKGROUND

Reports are often used to inform a reader about selected topics of interest so that information can be used to provide a general view on the subject at hand, to drive decision making, etc. Reports may also include persuasive elements, such as recommendations, suggestions, or other motivating conclusions that indicate possible future actions the report reader could take. The reports can be in different forms, such as graphs, text, tables, and so on; typically, the reports can be disseminated as a set of regularly updated Web pages. Alternatively, they may be emailed directly to users or simply printed out and distributed. There are different types of business reporting, for example, informational reporting, analytical reporting, operational reporting, and so on.

### SUMMARY

Methods and apparatus, including computer program products, are provided for reporting and analytics for development entities.

In one aspect, there is provided a computer-implemented method. The method may include selecting a development entity model for generating a report including development information regarding the development entities corresponding to the selected model, the development entity model representing an element being developed for a system; configuring a report model for the selected development entity model to enable creation of the report model; and saving the report model for the selected development entity model, the saved report model stored with other report models defining other reports for operational business objects used in conjunction with the system.

In some implementations, one of more variations may be made as well as described in the detailed description below and/or as described in the following features. The element being developed may include at least one of a business object and another development entity. The report model may be created for the selected development entity model. The reporting model may include a selection structure, a result structure, and a filter and expression structure. The report may be generated based on the saved report model. The report may include information for a development process of the system. The selected development entity model may be presented at a user interface to specify one or more attributes of the development entity model. The selected development entity model may be configured to include a status of the selected development entity, wherein the status indicates one or more of in process, released, in test, and in error.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts a block diagram of a system for real-time operational reporting and analytics on development entities;

FIG. 2A depicts a design time view of a report on a business object;

FIG. 2B depicts a design time view of a report on a development entity;

FIG. 3 depicts a process for real-time operational reporting and analytics; and

FIG. 4 depicts an example of a reporting metadata model, which may be used for business objects and development entities.

Like labels are used to refer to same or similar items in the drawings.

### DETAILED DESCRIPTION

A business application may be used in connection with a business process. When this is the case, real-time reporting and analytics may be implemented to allow business applications developers and key users to build reporting and analytical content on the business process via the business application including one or more business objects. Once built, the reporting and analytical content provides a user with information regarding the business process. Although the reporting and analytical content provides useful information, the software development process may also require reporting and analytical content for development entities. The phrase “development entities” refers to an entity being developed. Examples of development entities include a component being developed for the business application and/or a business object being developed for the business application. These development entities may also require real-time reporting and analytics to support software development. For example, a software developer and/or a quality engineer involved in the software development process may implement real-time reporting and analytical content to monitor and track the software development of the business application including the development entities being developed. The subject matter described herein relates to using the reporting and analytical framework provided within the business application for operational business objects to be used for reporting and analytics of development entities to allow monitoring and tracking during the software development process.

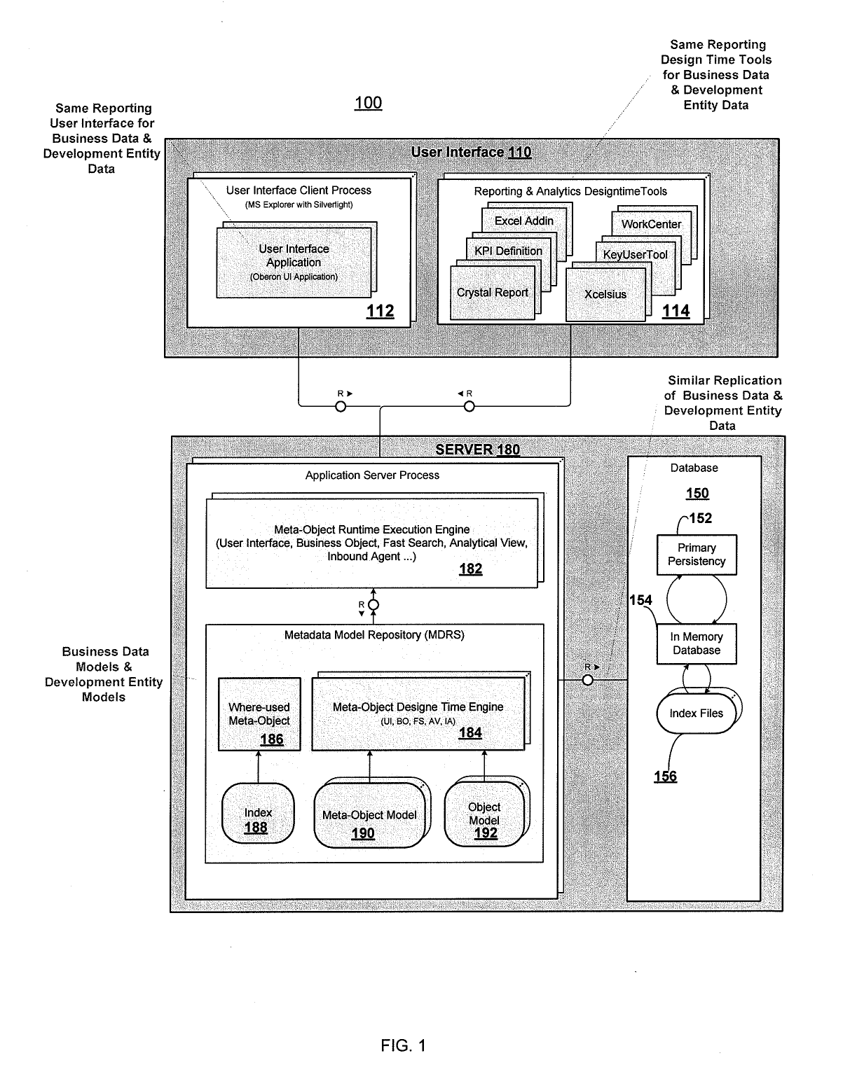

FIG. 1 depicts a system 100 including a user interface 110 and a server 180. The user interface 110 further includes a user interface client 112 and reporting and analytic design time tools 114.

The user interface client 112 may be implemented as any mechanism enabling interaction with the data and/or methods at server 180. For example, user interface 112 may be implemented as a browser or a thin client application.

The reporting and analytic design time tools 114 may include a user interface designer component for designing and configuring the reporting and analytic content and any models to be used in connection with the design and configuration of the reporting/analytic content. The reporting and analytic design time tools 114 may also include a spreadsheet component for generating reports and analytic documents, a workbench to design and generate the reports and analytics, dashboards, simple list reports, multi dimensional, pixel perfect reports, key performance indicators and the like. The reporting and analytic design time tools 114 may, as noted, provide a mechanism for building reporting and analytics models on different development entities based on the defined reporting and analytics metamodel in the system, and user interface elements used when building reports and analytics for the development entities. For example, the reporting and analytic design time tools 114 may use a model stored at server 180 to enable a user to build, during design time, reports and analytics on the development entities, which are instances of the stored model. Moreover, the reporting and analytic design time tools 114 may allow defining and/or configuring a reporting model, which is then stored in server 180. This defined report model may be used to define a flat report or analytics for a development entity. For example, the defined report model for the report may define a simple spreadsheet or word processing document, while analytics may be defined by the report model as a more complex pivot table. In any case, the report model for the development entities is stored in server 180 along with other report models stored at server 180 for operational business objects, enabling the report model for the development entities to use the same reporting and analytics framework as the operational business objects.

The development entity may comprise one or more business objects being developed and stored in server 180. In this example, the model for a report or analytic may be stored at server 180 as attributes of the development entity. To illustrate further, the model (which was designed and/or configured during design time for a development entity) may be stored at server 180 to define a report and/or analytics for the development entity. The model is stored in server 180 along with other models stored at server 180 for operational business objects, enabling the model for the development entities to use the same framework as the operational business objects.

During the development process of the development entities, a user is able to execute, during runtime, the as-built operational report and analytics by sending a request via the user interface 112 and server 180. The request is handled by the appropriate metaobject runtime execution engine 182 (in this case analytical view runtime execution engine), where processing of the request occurs and a corresponding report or analytic document is generated for the development entity based on the stored object model 190.

As noted, a business application may be used in connection with a business process, which may generate (and/or consume) business data. This business data may be structured in accordance with a predetermined format, such as a business object. A business object may be implemented as an object representing a business domain supported by the business application. For example, a sales order entry business application may have one or more business objects, which represent orders, line items, and sales orders being processes. When the sales order business object is being developed, the sales order business object is considered a development entity. The business object may also include methods (e.g., one or more functions) and data (e.g., attributes), which may also provide standardized, domain-specific access interfaces to the data. Business objects may be associated with other business objects to enable exchanges of information among the business objects.

The data contained in a business object may be modeled using a modeling language of a business object model (business object metadata model). This business object model is an abstraction that presents the relations of a group of entities, and this model may conform to a unique metamodel. For example, a model may conform to its metamodel in the same way a computer program conforms to the grammar of the programming language in which it has been written. The metamodel is yet another abstraction that highlights some of the properties (e.g., attributes, elements, etc.) of the model itself. These models and metamodels may be used to construct, during design time, reports and analytics for the business application including the business objects, as well as reports and analytics for the development entities.

To illustrate, a user may create a report based on a model (or metamodel) for the report by choosing one or more development entities (or business objects) and selecting particular attributes of the development entities (or business objects) that represent the relevant business data (e.g., a sales order). These selections are defined in the report model. Moreover, the report model may define which development entity (or business object) data is to be exposed from the model and which data is to be seen in the report. The report model may consist of several structures including, but not limited to, a selection structure, a result structure, and a filter and expression structure. Elements of the selection structure and elements of the result structure may be defined in the report model as elements with attributes of the underlying development entities (or business objects), which contain the relevant reporting business data. Examples of models and metamodels of business object can be found in U.S. United States Patent Application 2011/0087708, entitled “BUSINESS OBJECT BASED OPERATIONAL REPORTING AND ANALYSIS,” which is incorporated in its entirety herein. The report model (which may be stored in object model 192) may also enable generation of a report for a business object and a development entity being developed at system 100.

A report may be constructed, during design time, by creating a report model and executing, during runtime, the created report model. However, traditional reporting during the development process typically relies on a third-party system to monitor and track the entities being developed. Moreover, traditional reporting may implement mechanisms unique to the third party, and as such, any reporting and analytics would require transformation and adaptation to the framework being used by the entities being developed. In some implementations consistent with the subject matter described herein, the operation framework including existing models may be used to define models for reporting and analytics of the development entities, which may thus reduce some, if not all, of the required transformation and adaptations.

The server 180 may further include a runtime execution engine 182, metaobject design time engine 184, where-used metaobjects 186, and a database 150.

The metaobject design time engine 184, where-used metaobjects 186, and database 150 include both business object information (e.g., business data for the business object sales order and/or product) and development entity information (e.g. models and for the business objects, work centers, and/or process agents) to enable using the same reports and analytics framework for the development entities and operational business objects. The metaobject design time engine 184 is used to define and administer a specific model (e.g., a reporting and analytics model or a business object model). The where-used metaobject 186 includes association information defined between models or metamodels. The database 150 may be implemented as an in-memory database that enables execution of reporting on operational business data or development entities in real-time.

The metaobject runtime execution engine 182 (also referred to as an engine, a runtime execution engine, and/or an execution engine) receives from user interface 112 a request for a report on a development entity. The runtime execution engine 182 access metaobject data 184 and where-used information 186 to determine what development entity to access, where the development entity is located, what data to access from the development entity, and how to generate a report and/or analytics to respond to the request received from the user interface 112. The runtime execution engine 182 may also access the metaobject model 190 (and/or object model 192) to access a model to determine what development entity to access, what data to access from the development entity, and/or how to generate a report and/or analytics. The runtime execution engine 182 may also access where-used metaobject 186 and index 188 to determine further associated entities. The metaobject 184 may also access database 150, such as in-memory database 154 and/or primary persistency 152, to obtain data for the development entity corresponding to the business object or other development object model being developed and to obtain data for the report/analytics.

The metaobject design time engine 184 represent data including business object data and development entity data that may be configured in accordance with a metaobject model 190 and/or an object model 192. The where-used metaobject 186 may access an index 188 to determine where specific data, such as a business object data and development entity data, is being used in a system. The database 150 may further include a persistency mechanism 152 to store data in a persistent manner, and in-memory database 154 to store data in memory, and index files 156. The in-memory database 154 stores data in memory, such as random access memory (RAM), dynamic RAM, FLASH memory, and the like, rather than persistent storage to provide faster access times to the stored data.

In some implementations, the development entities of system 100 may be reported and analyzed using the same framework provided in system 100 for operational business objects. For example, a sales order business object may be used to provide standardized and domain specific access interfaces to a business application needing business data. In system 100, a sales order development entity (which corresponds to the sales order business object) may also be defined using the same models as the operational business objects. In this example, reporting of a sales order business object (which defines the reporting of a sales order using one or more business objects) or a factsheet floor plan (which defines the development entity) both use the same reporting and analytics framework of system 100. Specifically, the metadata-centric reporting and analytics framework of system 100, which is typically designed for business objects, may also be used for development entities because the development entities are modeled in system 100 using the same metadata model as used by the business objects.

In some implementations, the reporting model may be defined as a selection structure, a result structure, a filter structure, and/or an expression structure. The design time aspects of a model are referred to as design time artifacts, and the runtime aspects of a model are referred to as runtime artifacts. These structural elements may be defined as data (e.g., attributes) of the underlying development entities model containing relevant reporting and analytics of development data for the development process. When stored at server 180 using an in-memory or a fast search provider, views are generated for presentation as a report or analytic at the user interface 112, and development data may be replicated to the in-memory database 154 to enable storage and fast retrieval. When reporting on development data is executed, the appropriate data is retrieved from the in-memory database 154 and handed over to engine 182 using the same mechanisms as operational, business object data. Reporting and analytics content is constructed by defining a multidimensional analytics view (MDAV) and reports in the metadata repository system (MDRS) based on development entities. Reporting and analytics models are created for the development entities as described above. For replication of development to the in-memory database 154, a non-tenant specific replication may be implemented. Contrary to business data that are tenant specific in a multi-tenant system, the development entities are valid and should be available across tenants, and therefore the replication of the development entities to the in-memory database may include cross tenant replication

In some implementations, the system 100 may use, during design time, the reporting and analytics framework of system 100 and, in particular, may use the business object metadata models defined in a metadata model repository. The metadata model repository may also store the business object models and other development entities models as a repository model using the business object metadata model. This leads to the models defined in the metadata model repository as being seen, or exposed to, different consumers to some extent as a business object. Accordingly, models defined in the metadata model repository can be exposed to the reporting and analytics framework of system 100, although different models, such as a model representing business entity like a sales order business object, or a model representing a development entity in a development area, may be treated the same by the reporting and analytics framework of system 100.

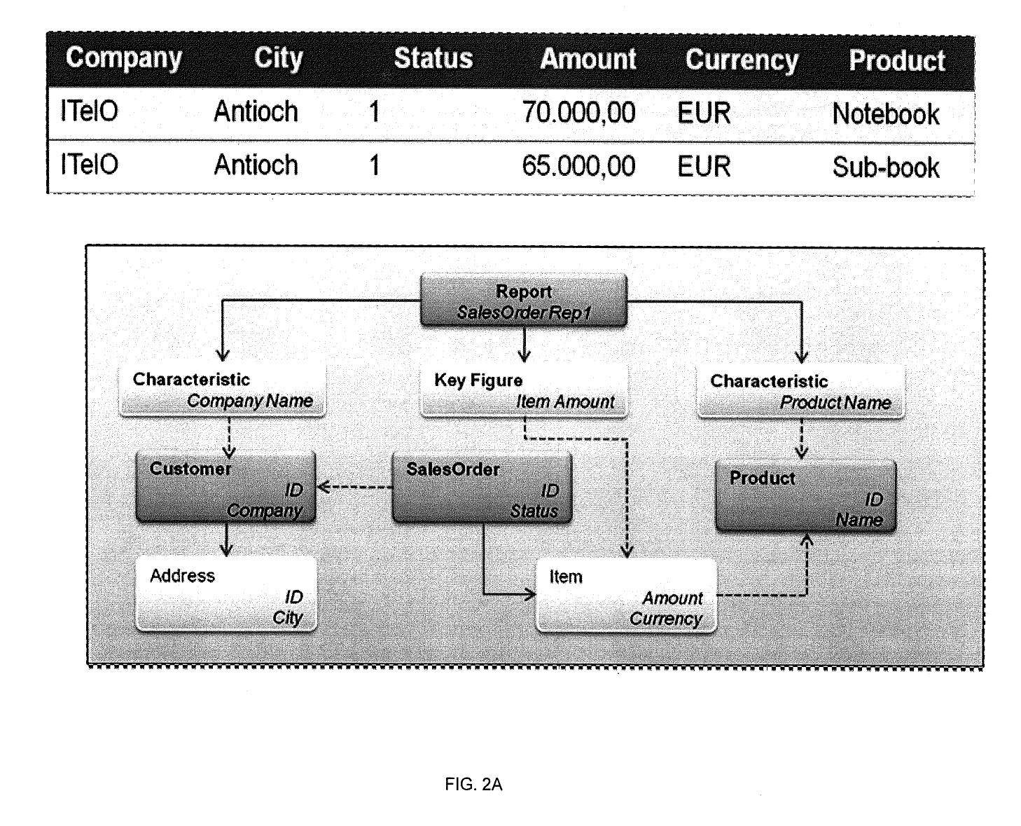

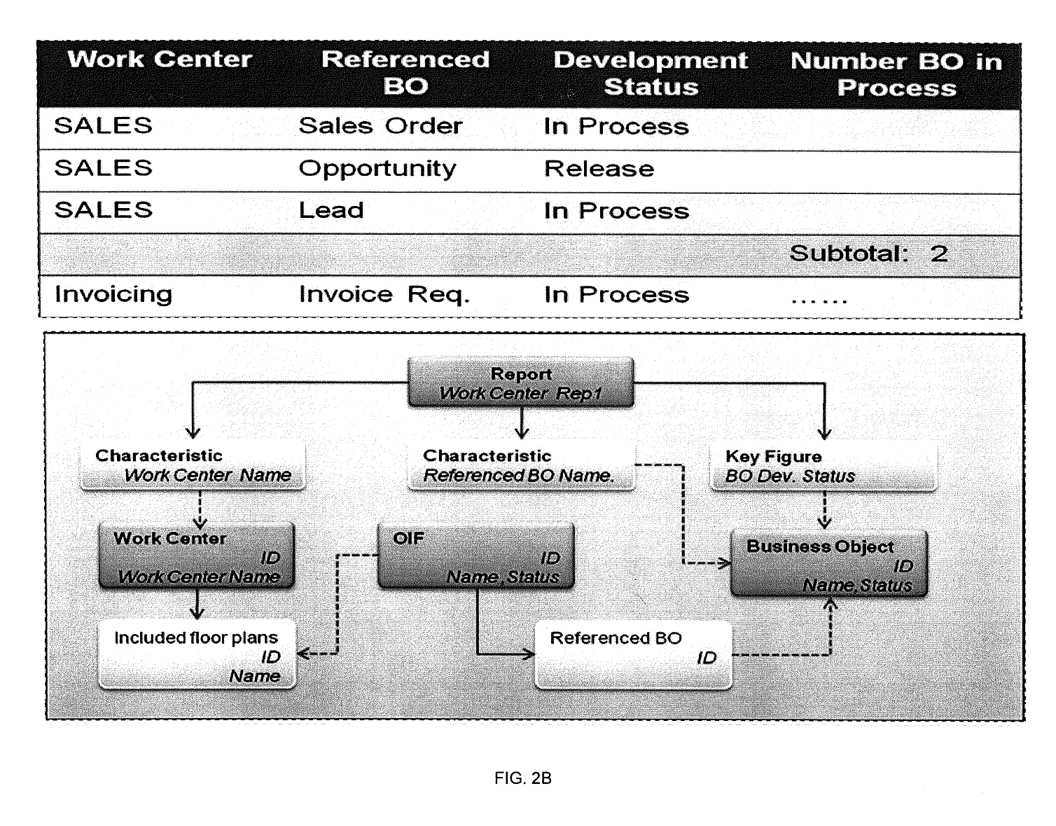

FIG. 2A shows a design time view or model of a report on a sales order business object being handled by system 100, and FIG. 2B show a design time view or model of a report on a development entity for a work center for sales orders. Referring to FIG. 2B, the work center represents one or more development entities being developed, which in the case of FIG. 2B entities correspond to sales work center and includes sales order development entities, opportunity development entities, and lead development entity. The development entities may have attributes defining a status, which may be stored as an attribute (see, e.g., “BO Dev. Status”). These status attributes may correspond to the whether the development entities are in the process of development, released for final test and installation, and the like. The attributes may also include development related data, such as floor plans and the like. Moreover, the development entities may each be defined in accordance with a model to support reports and analytics. In the example of FIG. 2B, development entities may be defined to include, or linked to, the report object node (labeled “Report”), which is associated with data and other attributes defining a report or other analytics as depicted at FIG. 2B. FIG. 2A shows a report model on business data level. The report shows operational data of sales order instances. The report structure and attributes are related or associated with attributes of different business objects, such as sales order, customer, product, etc. FIG. 2B thus shows a report model on development entities level (e.g., a report on work center model), and the reports shows data for work center instances. The report structure and attributes are related, or associated with, attributes for different development models, such as work center, floor plan, user interface screens, business objects, and the like.

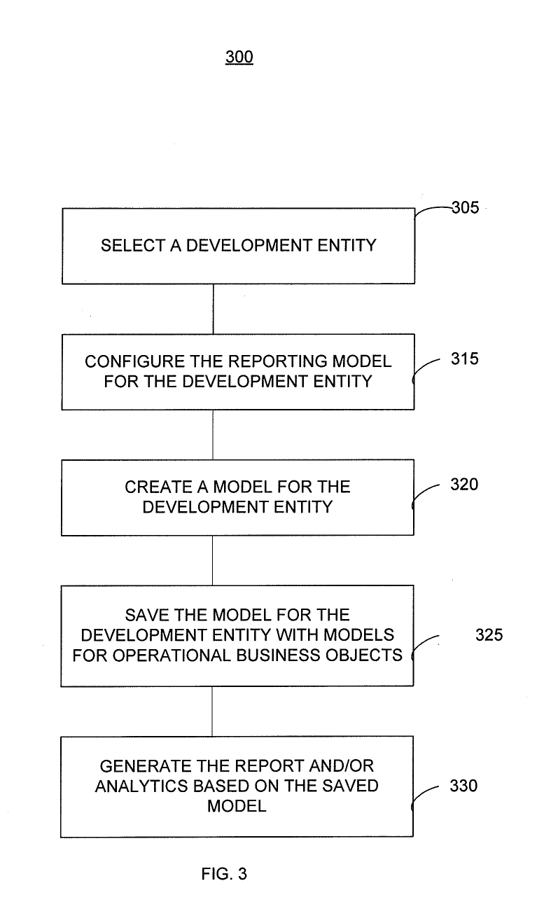

FIG. 3 depicts a design time process for configuring reports and analytics for development entities.

At 305, a development entity model is selected. In some implementations, reporting and analytics design time tools 114 accesses server 180 where the development entities models are stored.

At 315 reporting model for the selected development entities models may be configured. For example, reporting and analytics design time tools 114 may present the selected development entity model and allow the user to build a report model for the selected development entity model including attributes of the development entity model. For example, reporting and analytics design time tools 114 may be used to specify, for the report model, one or more attributes of the development entity model to be reported as data in the report or the analytic. Moreover, reporting and analytics design time tools 114 may be used to specify, in the report model, that the development entity status, such as in process, released, in test, in error, and the like, is to be included in a report (e.g., by including a status attribute, which is part of the development entity model, in the report model).

The reporting and analytics design time tools 114 may be used to define, in the report model, more complex data attributes and operations as well. For example, one or more attributes of the development entity or/and associated development entities may be filtered, aggregated, sorted, and the like for inclusion in the report/analytic. Moreover, existing attributes of associated development entities may be included in a report. For example, as shown in FIG. 2B beside the display name for the development entity “Work Center” the display name and the status of the associated development entity “Business Object” is included in the report. Once a report model for the selected development entity model has been configured to include the attributes required for the report or analytic, the created report model is stored in the object model 192.

Once report model for the selected development entity model has been configured to include the elements required for the report or analytic, the report model may be created at 320. To create the report model for a development entity model and its elements, a data structure is created. The data structure may be a flat structure (e.g., a row of attributes) providing the specific data attributes selected from the development entities model. This flat structure may represent a portion of the report/analytic model.

At 325, the model created at 320 is saved to object model 192.

At 330, the report/analytic is generated from the saved model to enable a preview of the report/analytic. For example, a set of user interface elements (e.g., tab, window, text, field, table, etc.) is generated to represent the data from the flat structure defining the report model. The user interface 112 may be used to further select which elements to be shown or hidden in the report (end user specific personalization). When executed, the designed report model is presented at the user interface 112 including data. During runtime, the meta-object runtime execution engine receives a request from the user interface to provide a report on specified development entity model, and in response, generates the report using the stored report model for the development entity model.

Based on reporting models defined and stored in the metadata model repository, corresponding run time artifacts such as in-memory dataviews are generated for each flat file report or analytical report. The generated runtime artifact(s) may be generated in connection with run time engines, such as engine 182. Runtime engine 182 processes the corresponding runtime artifact when a report is displayed in the user interface 112. In this context, the phrase “data retrieval artifact” is used to refer to an in-memory dataview representing the report or analytic of the development entity at runtime. The in-memory dataview is a runtime artifact that is used to retrieve data from the in-memory database 154 to enable, in some implementations, enhanced performance, when compared to accessing the dataview from a persistency comprising mechanical and/or optical storage based mechanisms. For business objects and development entities, the in-memory dataviews of the reports and analytics are processed by engine 182 in a response to a request from the user interface 112 for the report or analytics. Moreover, the corresponding data in the dataview may be stored in the in-memory database, such as database 154, in accordance with isolation between tenants to provide privacy and security among users, although some data may be shared, under controlled conditions, with a plurality of tenants (e.g., to enable data reduction).

In some implementations, system 100 may be implemented as a system hosting multiple tenants (referred to as a multitenant system). In a multi-tenant system, data for a development entity may be replicated to the in-memory database 154 in a so-called “development tenant,” when developers make changes to the development entities. The development entity data may typically be implemented as tenant independent, although cross tenant data retrieval of data related to development entities may be used as well to enable data reduction across tenants in a system. The in-memory data views generated for reporting artifacts based on development entities will initiate tenant independent data replication and data retrieval.

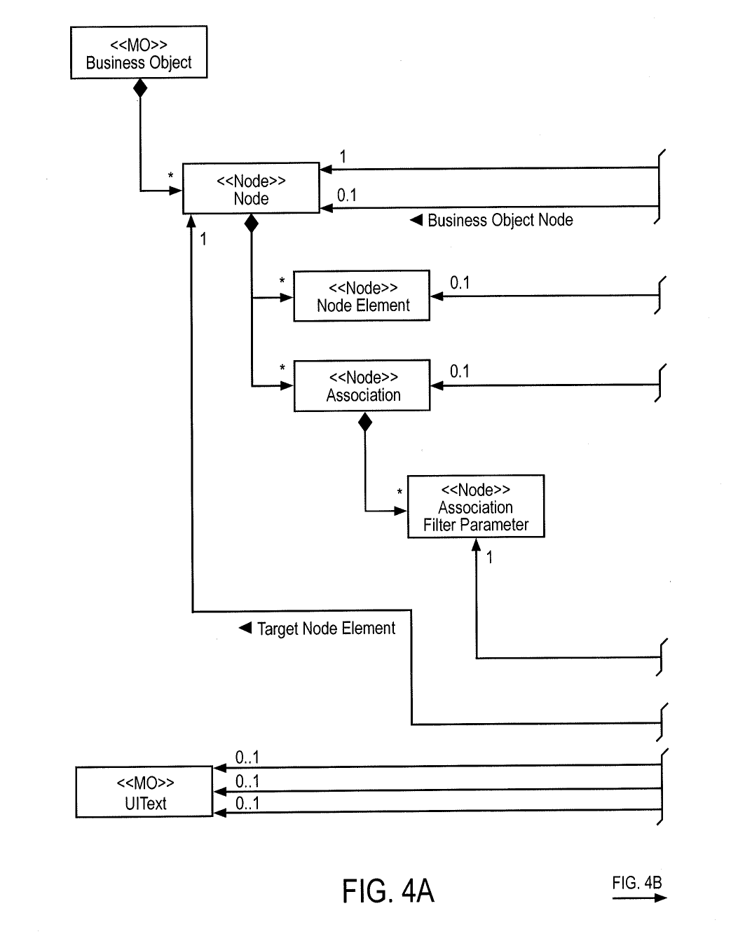

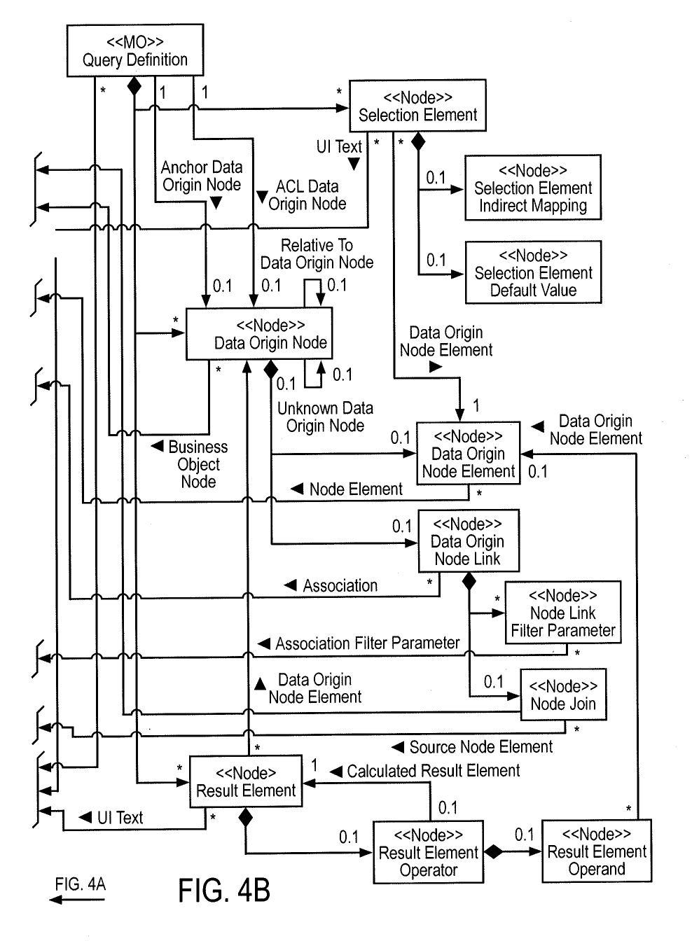

FIG. 4 depicts an example of a reporting metadata model based on business object metadata model. The left side of the drawing shows elements of the business object metadata model, such as nodes, node elements, composition associations, and cross objects association. The right side of the drawing shows an element of a reporting metamodel (which in this example corresponds to a query definition). The reporting metamodel is composed of similar elements like the business objects metamodel (e.g. nodes node elements, associations, etc.). Those metamodel elements reference, and are related with cross object associations to, the business object metamodel elements

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. Furthermore, the phrases “based on” and “based on at least” are used interchangeably herein as both phrases are equivalent. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A computer-readable medium containing instructions to configure a processor to perform operations comprising:
selecting a development entity model for generating a report including development information regarding the development entities corresponding to the selected model, the development entity model representing an element being developed for a system;
configuring a report model for the selected development entity model to enable creation of the report model; and
saving the report model for the selected development entity model, the saved report model stored with other report models defining other reports for operational business objects used in conjunction with the system.

2. The computer-readable medium of claim 1, wherein the element being developed includes at least one of a business object and another development entity.

3. The computer-readable medium of claim 1 further comprising:
creating the report model for the selected development entity model.

4. The computer-readable medium of claim 3, wherein the report model comprises a selection structure, a result structure, and a filter and expression structure.

5. The computer-readable medium of claim 1 further comprising:
generating, based on the saved report model, the report including information for a development process of the system.

6. The computer-readable medium of claim 1 further comprising:
presenting the selected development entity model at a user interface to specify one or more attributes.

7. The computer-readable medium of claim 1, wherein the configuring further comprises:
configuring the selected development entity model to include a status of the selected development entity, wherein the status indicates one or more of in process, released, in test, and in error.

8. A method comprising:
selecting a development entity model for generating a report including development information regarding the development entities corresponding to the selected model, the development entity model representing an element being developed for a system;
configuring a report model for the selected development entity model to enable creation of the report model; and
saving the report model for the selected development entity model, the saved report model stored with other report models defining other reports for operational business objects used in conjunction with the system.

9. The method of claim 8 further comprising:
creating the report model for the selected development entity model.

10. The method of claim 9, wherein the report model comprises a selection structure, a result structure, and a filter and expression structure.

11. The method of claim 8 further comprising:
generating, based on the saved report model, the report including information for a development process of the system.

12. The method of claim 8 further comprising:
presenting the selected development entity model at a user interface to specify one or more attributes.

13. The method of claim 8, wherein the configuring further comprises:
configuring the selected development entity model to include a status of the selected development entity, wherein the status indicates one or more of in process, released, in test, and in error.

14. A system comprising:
at least one memory;
at least one processor, wherein the at least one memory and the at least one processor are configured to provide operations comprising:
selecting a development entity model for generating a report including development information regarding the development entities corresponding to the selected model, the development entity model representing an element being developed for a system;
configuring a report model for the selected development entity model to enable creation of the report model; and
saving the report model for the selected development entity model, the saved report model stored with other report models defining other reports for operational business objects used in conjunction with the system.

15. The system of claim 14 further comprising:
creating the report model for the selected development entity model.

16. The system of claim 15, wherein the report model comprises a selection structure, a result structure, and a filter and expression structure.
